(19) United States
(12) Patent Application Publication
(10) Pub. No.: US 2026/0227792 A1
(43) Pub. Date: Aug. 6, 2026

(54) Obstacle Detection for Autonomous Vehicles

(71) Applicant: Autonomous Solutions, Inc., Mendon, UT (US)

(72) Inventor: Taylor Bybee, Mendon, UT (US)

(73) Assignee: Autonomous Solutions, Inc., Mendon, UT (US)

(21) Appl. No.: 19/409,037

(22) Filed: Dec. 4, 2025

Related U.S. Application Data
(60) Provisional application No. 63/753,943, filed on Feb. 5, 2025.
(60) Provisional application No. 63/769,713, filed on Mar. 10, 2025.

(51) Int. Cl. G05D 1/622; A01B 69/00; A01B 69/04; A01D 34/00; A01D 101/00; G05D 111/10; G06V 10/764; G06V 20/58; G06V 20/59; H04N 7/18

(52) U.S. Cl. CPC G05D 1/622; G06V 10/764; G06V 20/58; G06V 20/597; H04N 7/181; A01B 69/001; A01B 69/004; A01B 69/008; A01D 34/008; A01D 2101/00; G05D 2111/10

(57) ABSTRACT

An autonomous vehicle is disclosed that includes a camera system; a controller; and an obstacle detection system in communication with the camera system. The obstacle detection system, for example, may be configured to receive visual data from the camera system; and calculate a probability of an obstacle being present based on the visual data. The controller, for example, may be configured to determine the presence of an obstacle if a calculated probability in the obstacle detection system is above a probability threshold; and send an inhibit signal to stop or inhibit movement of the autonomous vehicle.

### BACKGROUND

Autonomous vehicles which are not continually monitored by operators benefit from obstacle detection systems which can prevent collisions with obstacles, particularly people or animals.

### SUMMARY

In some examples, an autonomous vehicle includes: a camera system; a controller; and an obstacle detection system in communication with the camera system, wherein the obstacle detection system is configured to: receive visual data from the camera system; and calculate a probability of an obstacle being present based on the visual data; and wherein the controller is configured to: determine the presence of an obstacle if a calculated probability in the obstacle detection system is above a probability threshold; and send an inhibit signal to stop or inhibit movement of the autonomous vehicle.

In some examples, the controller is configured to activate the obstacle detection system at start-up of the autonomous vehicle.

In some examples, the controller is configured to keep the obstacle detection system active at all times during autonomous operation.

In some examples, an autonomous vehicle, further including a vehicle speed sensor configured to determine the speed of the autonomous vehicle; wherein the controller is configured to: receive speed data from the vehicle speed sensor, and, determining if the speed of the autonomous vehicle is below a speed threshold based on the speed data, and if the speed is determined to be below the speed threshold, activate the obstacle detection system.

In some examples, an autonomous vehicle, further including a vehicle speed sensor configured to determine the speed of the autonomous vehicle; wherein the controller is configured to: receive speed data from the vehicle speed sensor, and, determine if the speed of the autonomous vehicle is above a speed threshold based on the speed data; and if the speed is above a speed threshold, activate the obstacle detection system.

In some examples, the camera system includes a front-facing camera to provide visual data of the front and/or front sides of the autonomous vehicle.

In some examples, the camera system includes a camera facing an operator seat on the autonomous vehicle.

In some examples, the camera system includes a camera selected from the group consisting of a camera with a fish-eye lens, an electro-optical camera, a stereo camera, a depth camera, an infrared camera, a neuromorphic camera, and a hyperspectral camera.

In some examples, the camera system includes a rear-facing camera, and wherein the controller is configured to activate the obstacle detection system when the vehicle is reversing.

In some examples, calculated probabilities are filtered based on a Bayes filter, a hidden Markov model, or a moving average filter.

In some examples, the obstacle detection system includes a cascade classifier or deep learning algorithm.

In some examples, the autonomous vehicle is a mower, a yard truck, a loader, a wheel loader, a track loader, a dump truck, a digger, a backhoe, a forklift, a harvester, a tractor, a land leveler, a scraper, a dozer, a trencher, a grader, a seeder, a fertilizer, or a harrow.

In some examples, a method of controlling an autonomous vehicle, the method including: activating an obstacle detection algorithm including: receiving visual data relating to data from a camera system on the autonomous vehicle; calculating a probability of an obstacle being present based on the visual data; if the probability is above a probability threshold: determining the presence of an obstacle; and sending an inhibit signal to stop or inhibit movement of the autonomous vehicle.

In some examples, a method, including determining whether the autonomous vehicle is at start-up, and activating the obstacle detection system if it is determined to be at start-up.

In some examples, a method, including determining whether the autonomous vehicle is operating autonomously, and keeping the obstacle detection system active at all times during autonomous operation.

In some examples, a method, further including: receiving speed data relating to speed of the autonomous vehicle; determining if the speed of the autonomous vehicle is below a speed threshold based on the speed data; if the speed is determined to be below the speed threshold, activating the obstacle detection system.

In some examples, a method, further including: receiving speed data relating to speed of the autonomous vehicle; determining if the speed of the autonomous vehicle is above a speed threshold based on the speed data; if the speed is determined to be above the speed threshold, activating the obstacle detection system.

In some examples, a method, wherein the camera system includes a rear-facing camera, and wherein the method includes: determining whether the vehicle is being controlled to reverse, and if the vehicle is being controlled to reverse, activating the obstacle detection system.

In some examples, a method, including filtering, based on a Bayes filter, a hidden Markov model, or a moving average filter, calculated probabilities.

In some examples, a method, wherein the autonomous vehicle is a mower, a yard truck, a loader, a wheel loader, a track loader, a dump truck, a digger, a backhoe, a forklift, a harvester, a tractor, a land leveler, a scraper, a dozer, a trencher, a grader, a seeder, a fertilizer, or a harrow.

In some examples, a method of controlling an autonomous vehicle, the method including: receiving velocity data relating to the speed of the autonomous vehicle and its direction of travel or intended direction of travel, including forward and reverse directions; if the speed is determined to be below a speed threshold, initiating an obstacle detection algorithm including: receiving visual data relating to data from a camera system on the autonomous vehicle; calculating a probability of an obstacle being present based on the visual data; if the probability is above a probability threshold: determining the presence of an obstacle; and sending an inhibit signal to stop or inhibit movement of the autonomous vehicle; wherein the visual data is received from a front-facing camera if the direction of travel or intended direction of travel is forward, and wherein the visual data is received from a rear-facing camera if the direction of travel or intended direction of travel is reverse.

### BRIEF DESCRIPTION OF THE FIGURES

FIG. 1 is a sideview of an example autonomous yard truck.

FIG. 2 is a sideview of an autonomous tractor.

FIG. 3 is an isometric view of an autonomous mower.

FIG. 4 illustrates a block diagram of an example autonomous vehicle communication system of the present disclosure.

FIG. 5 is a flow chart of an example process for controlling the autonomous vehicle.

FIG. 6 is a flow chart of a first example process for activating an obstacle detection system.

FIG. 7 is a flow chart of a second example process for activating an obstacle detection system.

FIG. 8 is a block diagram of an example computational system (or controller).

### DETAILED DESCRIPTION

Systems and/or methods are disclosed for an autonomous vehicle and a method of controlling an autonomous vehicle. Some embodiments may include determining a probability of an obstacle being present in visual data using machine learning algorithms.

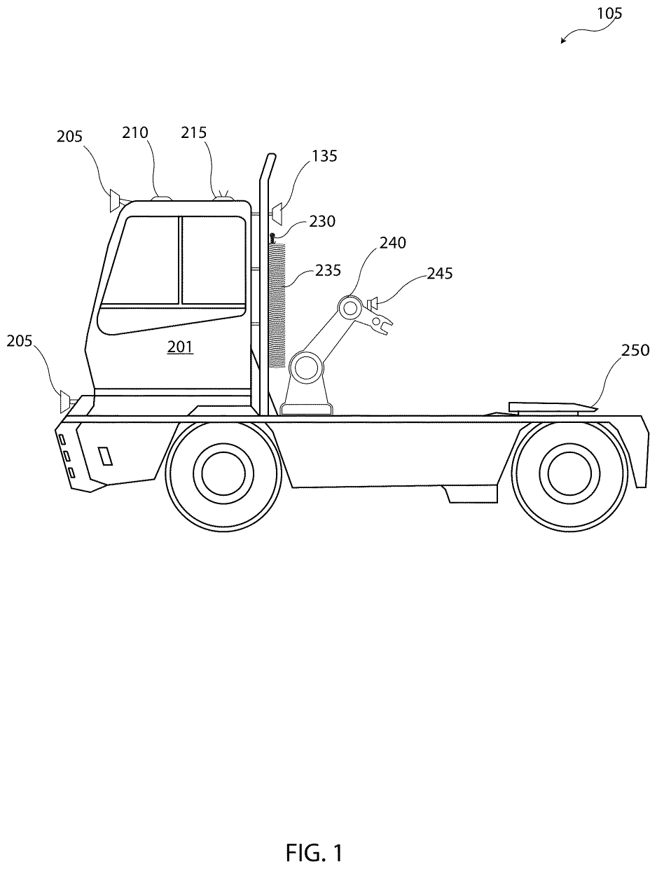

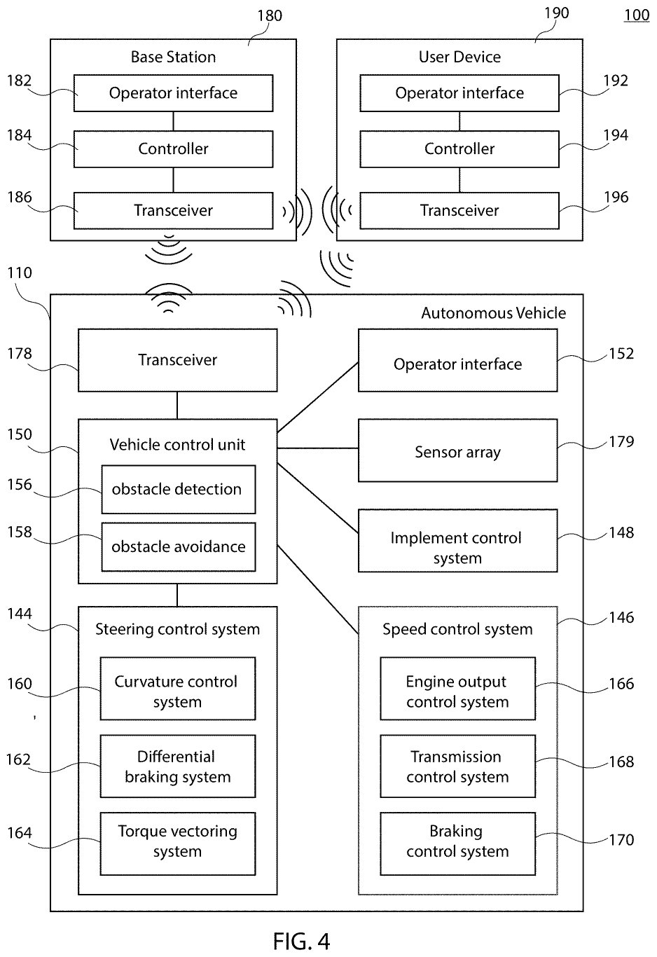

FIG. 1 shows an autonomous yard truck 105 which may be any type of autonomous yard truck. The autonomous yard truck 105 includes a cab 401 that may be used to drive the autonomous yard truck 105 manually. The autonomous yard truck 105 may include one or more controllers as described with reference to FIG. 4. The autonomous yard truck 105 may also include a brake system, an engine, a transmission, steering, etc.

In some embodiments, the autonomous yard truck 105 may include a sensor array that includes sensors 405 disposed at various locations on the autonomous yard truck 105 such as, for example, on the cab 401, bumper, housing, frame, etc. The sensors 405 may include infrared sensors, ultrasonic sensors, magnetic sensors, radar sensors, Lidar sensors, terahertz sensors, sonar sensors, a camera system including one or more cameras, etc. The cameras may be arranged to be front-facing to provide visual data of the front and/or front sides of the autonomous yard truck 105, rear-facing to provide visual data of the rear and/or rear sides of the autonomous yard truck 105, and/or internally within the cab 401 to provide visual data of an operator seat within the cab 401. The cameras of the camera system, for example, may comprise a fish-eye lens to capture a wider field of view. The cameras of the camera system, for example, may comprise an electro-optical camera, a stereo camera, a depth camera, an infrared camera, a neuromorphic camera, and/or a hyperspectral camera.

In some embodiments, the autonomous yard truck 105 may include a spatial locating device (or GPS) antenna 410. In some embodiments, the autonomous yard truck 105 may include a transceiver antenna 415.

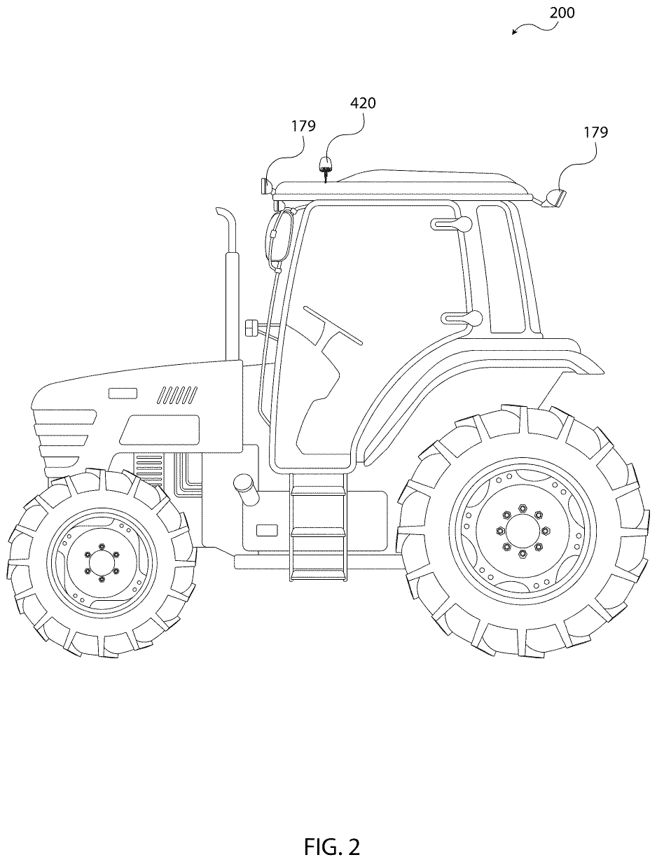

FIG. 2 is a sideview of an example autonomous tractor 200, which may include all or some of the components of autonomous vehicle 110. In this example, the autonomous tractor 200 may include standard tractor equipment and/or components. The autonomous tractor 200 may include or be coupled with any kind of implement such as, for example, plow, disc plow, reel mower, dumper, lift, bucket, shovel, blade, cutter, etc. The autonomous tractor 200, for example, includes a sensor array 179 (or multiple sensor arrays). The sensor array 179 may include, for example, one or more lidar, radar, and/or video cameras. The video cameras, for example, may include 360 degree cameras, a front facing camera, and/or a back facing camera.

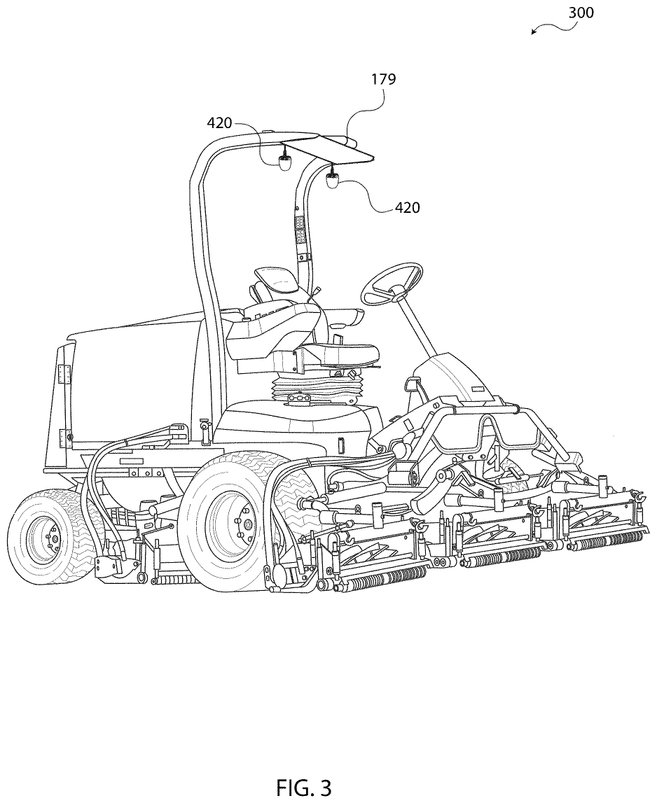

FIG. 3 is a sideview of an example autonomous mower 300, which may include all or some of the components of autonomous vehicle 110. In this example, the autonomous mower 300 includes a disc mower 345. Any type of mower or blades may be used instead of the disc mower. The autonomous mower 300, for example, includes a sensor array 179 (or multiple sensor arrays). The sensor array 179 may include, for example, one or more lidar, radar, and/or video cameras. The video cameras, for example, may include 360 degree cameras, a front facing camera, and/or a back facing camera. The sensor array 179, for example, may comprise a fish-eye lens to capture a wider field of view. The cameras of the camera system, for example, may comprise an electro-optical camera, a stereo camera, a depth camera, an infrared camera, a neuromorphic camera, and/or a hyperspectral camera.

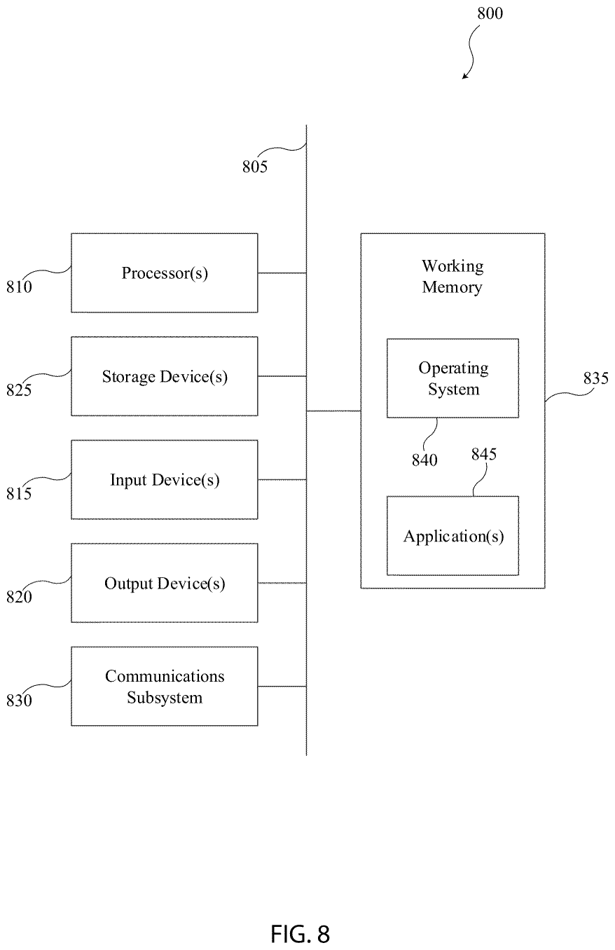

FIG. 4 is a block diagram of a communication and control system 100 that may be utilized in conjunction with the systems and methods of the disclosure. All or some of the components of control system 100 may or may not be included in an autonomous vehicle in any combination. All or some of the components of control system 100 may be included in an autonomous vehicle or a remote system in any combination. The communication and control system 100 may include a vehicle control unit 150 which may be mounted on an autonomous vehicle 110, such as the autonomous yard truck 105 of FIG. 1. In other examples, the autonomous vehicle 110 may include any agricultural or construction machinery including for example a loader, wheel loader, track loader, dump truck, digger, backhoe, forklift, harvester, tractor, land leveler, scraper, dozer, trencher, grader, mower, seeder, fertilizer, and harrow etc. The autonomous vehicle 110 may have an implement or attachment connected to it, such as a disc harrow, a bucket, a shovel, a blade, a thumb, a dump bed, a plow, an auger, a trencher, a scraper, a broom, a hammer, a grapple, forks, boom, spears, a cutter, a wrist, a tiller, a rake, a cultivator, a chisel, a mower, a grader, a harvester, a rake, a rock picker, a rotavator, a ditcher, a dozer blade, a backhoe, an excavator, a disc plow, a seeder, a fertilizer etc. The communication and control system 100, for example, may include any or all components of computational unit 800 shown in FIG. 8.

The communication and control system 100, for example, may include a sensor array 179. The sensor array 179 of the autonomous vehicle 110 may include any of the same sensors 205 as the sensor array of the autonomous yard truck 105. The sensor array 179, for example, may facilitate determination of condition(s) of the autonomous vehicle 110 and/or the work area. For example, the sensor array 179 may include one or more sensors (e.g., infrared sensors, ultrasonic sensors, magnetic sensors, tachometer, radar sensors, Lidar sensors, terahertz sensors, sonar sensors, wheel encoders, cameras, etc.) that monitor a rotation rate of a respective wheel or track and/or a ground speed of the autonomous vehicle 110. The sensors may also monitor operating levels (e.g., temperature, fuel level, etc.) of the autonomous vehicle 110. Furthermore, the sensors may monitor conditions in and around the work area, such as temperature, weather, wind speed, compass, humidity, and other conditions. The sensors of the sensor array 179, for example, cameras, may enable detection of physical obstacles in the work area, such as a parking stall, a material stall, accessories, other vehicles, obstacles, people, environmental features, or other obstacle(s) that may be in the area surrounding the autonomous vehicle 110.

The sensor array 179, for example, may include a velocity sensor which may include one or more of an inertial measurement unit, a compass, a GPS sensor, a wheel encoder, a tachometer, a camera, a radar, etc. The sensor array 179, for example, may also include a steering angle sensor. The velocity sensor, for example, may produce velocity data. Velocity data may include speed and/or bearing. Velocity data, for example, may also include steering angular rate.

The autonomous vehicle 110 may include a steering control system 144 that may control a direction of movement of the autonomous vehicle 110. The steering control system 144, for example, may include any or all components of computational unit 800 shown in FIG. 8.

The autonomous vehicle 110, for example, may include a speed control system 146 that controls the speed, acceleration, and deceleration of the autonomous vehicle 110. The speed control system 146, for example, may control the speed of the autonomous vehicle 110 based on map data, control algorithms, obstacle detection, start and/or stop points, input from a base station 180, etc. The speed control system 146, for example, may include any or all components of computational unit 800 shown in FIG. 8.

The autonomous vehicle 110, for example, may include an implement control system 148 that may control operation of an implement towed by the autonomous vehicle 110 or integrated within the autonomous vehicle 110 or coupled to the autonomous vehicle 110. The implement control system 148 may, for example, include any type of implement such as, for example, a bucket, a shovel, a blade, a thumb, a dump bed, a plow, an auger, a trencher, a scraper, a broom, a hammer, a grapple, forks, boom, spears, a cutter, a wrist, a tiller, a rake, etc. The implement control system 148, for example, may include any or all components of computational unit 800 shown in FIG. 8.

The autonomous vehicle 110, for example, may include an obstacle detection system 156 which may detect obstacles around the vicinity of the autonomous vehicle 110. The obstacle detection system 156 may detect obstacles using inputs from, for example, the sensor array 179. Additionally or alternatively, an obstacle avoidance system 158 may use data from the obstacle detection system 156 to create one or more alternative paths around obstacles detected by the obstacle detection system 156.

In this example, the obstacle detection system 156 and the obstacle avoidance system 158 may be part of the vehicle control unit 150. Alternatively, either or both the obstacle detection system 156 and the obstacle avoidance system 158 may not be part of the vehicle control unit 150. The obstacle detection system 156 and/or the obstacle avoidance system 158 may comprise separate controllers that communicate with vehicle control unit 150 and/or the sensor array 179 and/or the steering control system 144 and/or speed control system 146.

The vehicle control unit 150 may be communicatively coupled with the steering control system 144, the speed control system 146, the implement control system 148, and the obstacle detection system 156. The vehicle control unit 150, for example, may include any or all the components shown in FIG. 8. The vehicle control unit 150, for example, may be integrated into a single controller or may include a plurality of distinct components or controllers. The vehicle control unit 150 may be coupled with one or more sensors from the sensor array 179 and receive sensor data from the sensor array 179. The obstacle detection system 156 may be coupled with one or more sensors from the sensor array 179 and may directly receive sensor data from the sensor array 179. In other examples, the obstacle detection system 156 may be indirectly coupled to the sensor array 179, such as via the vehicle control unit 150.

The vehicle control unit 150, for example, may be used to control various aspects of the vehicle such as, for example, sending instructions to the steering control system 144, implement control system 148, speed control system 146, obstacle detection system 156, etc. The vehicle control unit 150, for example, may include a vehicle artificial intelligence (VAI) that may include one or more processors that execute one or more algorithms.

The vehicle control unit 150, for example, may receive signals relative to many parameters of interest including, but not limited to: vehicle position, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, obstacle detection, manual inputs from a user, and the like, or any combination thereof. These signals, for example, may come from the sensory array 179, from the obstacle detection system 156, or from base station 180.

The vehicle control unit 150, for example, may be an electronic controller with electrical circuitry configured to process data from the various components of the autonomous vehicle 110. The vehicle control unit 150 may include any or all of the components shown in FIG. 8, such as the processor 810, and a working memory 835. The vehicle control unit 150 may also include one or more storage devices and/or other suitable components of computational system 800. The processor may be used to execute software, such as software for calculating drivable path plans or may be used to execute an obstacle detection activation subsystem to determine whether the obstacle detection system 156 should be activated. Moreover, the processor may include multiple microprocessors, one or more “general-purpose” microprocessors, one or more special-purpose microprocessors, and/or one or more application specific integrated circuits (ASICS), or any combination thereof. For example, the processor 154 may include one or more reduced instruction set (RISC) processors.

The vehicle control unit 150, for example, may include a volatile memory, such as random-access memory (RAM), and/or a non-volatile memory, such as ROM (e.g., working memory 835 and/or storage device 825). The memory may store a variety of information and may be used for various purposes. For example, the memory may store processor-executable instructions (e.g., firmware or software) for the vehicle control unit 150 to execute, such as instructions for calculating drivable path plan, and/or controlling the autonomous vehicle 110. The memory may include flash memory, one or more hard drives, or any other suitable optical, magnetic, or solid-state storage medium, or a combination thereof. The memory may store data such as field maps, maps of desired paths, vehicle characteristics, software or firmware instructions and/or any other suitable data.

The steering control system 144, for example, may include a curvature rate control system 160, a differential braking system 162, a steering mechanism, and a torque vectoring system 164 that may be used to steer the autonomous vehicle 110. The curvature rate control system 160, for example, may control a direction of an autonomous vehicle 110 by controlling a steering control system of the autonomous vehicle 110 with a curvature rate, such as an Ackerman style autonomous vehicle, 110 or articulating vehicle. The curvature rate control system 160, for example, may automatically rotate one or more wheels or tracks of the autonomous vehicle 110 via hydraulic or electric actuators to steer the autonomous vehicle 110. By way of example, the curvature rate control system 160 may rotate front wheels/tracks, rear wheels/tracks, and/or intermediate wheels/tracks of the autonomous vehicle 110 or articulate the frame of the vehicle, either individually or in groups. The differential braking system 162 may independently vary the braking force on each lateral side of the autonomous vehicle 110 to direct the autonomous vehicle 110. Similarly, the torque vectoring system 164 may differentially apply torque from the engine to the wheels and/or tracks on each lateral side of the autonomous vehicle 110. While the illustrated steering control system 144 includes the curvature rate control system 160, the differential braking system 162, and the torque vectoring system 164, the steering control system 144 may include one or more of these systems. Further examples may include a steering control system 144 having other and/or additional systems to facilitate turning the autonomous vehicle 110 such as an articulated steering control system, a differential drive system, and the like.

The speed control system 146, for example, may include an engine output control system 166, a transmission control system 168, and a braking control system 170. The engine output control system 166 may vary the output of the engine to control the speed of the autonomous vehicle 110. For example, the engine output control system 166 may vary a throttle setting of the engine, a fuel/air mixture of the engine, a timing of the engine, and/or other suitable engine parameters to control engine output. In addition, the transmission control system 168 may adjust gear selection within a transmission to control the speed of the autonomous vehicle 110. Furthermore, the braking control system 170 may adjust braking force to control the speed of the autonomous vehicle 110. While the illustrated speed control system 146 includes the engine output control system 166, the transmission control system 168, and the braking control system 170, the speed control system 146 may include one or two of these systems. The speed control system 146, for example, may also include other systems and/or additional systems that may be used to control the speed of the autonomous vehicle 110.

The implement control system 148, for example, may control various parameters of the implement towed by and/or integrated within the autonomous vehicle 110. For example, the implement control system 148 may instruct an implement controller via a communication link, such as a CAN bus, ISOBUS, Ethernet, wireless communications, and/or Broad R Reach type Automotive Ethernet, etc.

The implement control system 148, for example, may instruct an implement controller to adjust a penetration depth of at least one ground engaging tool of an agricultural implement.

The implement control system 148, as another example, may instruct the implement controller to transition an agricultural implement between a working position and a transport portion, to adjust a flow rate of product from the agricultural implement, to adjust a position of a header of the agricultural implement (e.g., a harvester, etc.), among other operations, etc.

The implement control system 148, as another example, may instruct the implement controller to adjust a shovel height, a shovel angle, a shovel position, etc.

The obstacle detection system 156 may be configured to receive data from the sensor array 179 including, for example, visual data from cameras disposed on the autonomous vehicle 110. The cameras may include front-facing cameras to provide visual data of the front and/or front-sides of the autonomous vehicle 110, rear-facing cameras to provide visual data of the rear and/or rear sides of the autonomous vehicle 110 and/or internal cameras to provide visual data of the interior of the autonomous vehicle 110, such as an operator seat.

The obstacle detection system 156 may detect obstacles in the vicinity of the autonomous vehicle 110, and if an obstacle is detected, send an inhibit signal to the vehicle control unit 150 to inhibit movement of the autonomous vehicle 150. This reduces the likelihood of collisions with obstacles including people, thereby increasing the safety of the autonomous vehicle 110.

The obstacle detection system 156 may comprise a cascade classifier or deep learning algorithm for detecting obstacles.

The obstacle detection system 156 or the vehicle control unit 150 may receive data from the sensor array 179 including, for example, velocity data relating to the speed of the vehicle and/or the direction of travel, or intended direction of travel of the autonomous vehicle 110, and may activate the obstacle detection system 156 based on the speed data. For example, if the speed data received by vehicle control unit 150 indicates that the vehicle is travelling below a speed threshold, the vehicle control unit 150 may activate the obstacle detection system 156. In other examples, if the speed data received by the vehicle control unit 150 indicates that the vehicle is travelling above a speed threshold, the vehicle control unit 150 may activate the obstacle detection system 156. In other examples, the obstacle detection system 156 may be active at all times or may be activated only during start-up of the autonomous vehicle 150. In other examples, the obstacle detection system 156 may be activated only during reversing of the autonomous vehicle 110. In further examples, there may be data received from any other system on the autonomous vehicle 110 or on the base station 180, and there may be any combination of conditional criteria on which basis the vehicle control unit 150 may activate the obstacle detection system 156. In yet further examples, the sensor data, or data from any other systems on the autonomous vehicle 110 or base station 180, may be received by the obstacle detection system itself, and may activate an obstacle detection algorithm based on meeting any combination of suitable conditional criteria.

The operator interface 152, for example, may be communicatively coupled to the vehicle control unit 150 and/or the obstacle detection system 156 and configured to present data from the autonomous vehicle 110 via a display. Display data may include, for example, data associated with operation of the autonomous vehicle 110, data associated with operation of an implement, a position of the autonomous vehicle 110, a speed of the autonomous vehicle 110, a desired path, a drivable path plan, a target position, a current position, visual data from cameras of the area surrounding the autonomous vehicle 110 or within the autonomous vehicle etc. The operator interface 152 may enable an operator to control certain functions of the autonomous vehicle 110 such as starting and stopping the autonomous vehicle 110, inputting a desired path, etc. The operator interface 152, for example, may enable the operator to input parameters that cause the vehicle control unit 150 to adjust the drivable path plan. For example, the operator may provide an input requesting that the desired path be acquired as quickly as possible, that an off-path normal error be minimized, that a speed of the autonomous vehicle 110 remain within certain limits, that a lateral acceleration experienced by the autonomous vehicle 110 remain within certain limits, etc. In addition, the operator interface 152 (e.g., via the display, or via an audio system (not shown), etc.) may alert an operator if the desired path cannot be achieved, for example. The operator interface 152, for example, may also enable the operator to confirm or negate the presence of an obstacle when viewing visual data from cameras on the operator interface 152.

The vehicle control unit 150, for example, may include a base station 180 having a base station controller 184 located remotely from the autonomous vehicle 110. For example, the control functions of the vehicle control unit 150 may be distributed between the vehicle control unit 150 of the autonomous vehicle 110 and the base station controller 184. The base station controller 184, for example, may perform a substantial portion of the control functions of the vehicle control unit 150. For example, a first transceiver 178 positioned on the autonomous vehicle 110 may output signals indicative of vehicle characteristics (e.g., position, speed, heading, curvature rate, curvature rate limits, maximum turning rate, minimum turning radius, steering angle, roll, pitch, rotational rates, acceleration, obstacle detection in the vicinity of the vehicle etc.) to a second transceiver 186 at the base station 180. The base station controller 184, for example, may calculate drivable path plans and/or output control signals to control the curvature rate control system 160, the speed control system 146, and/or the implement control system 148 to direct the autonomous vehicle 110 toward the desired path, for example. The base station controller 184 may include a processor and memory device having similar features and/or capabilities as the processor and the memory device discussed previously. Likewise, the base station 180 may include an operator interface 182 having a display, which may have similar features and/or capabilities as the operator interface 152 and the display discussed previously.

In some embodiments, the base station 180 and/or the autonomous vehicle 110 may be in communication with a user device 190. A user device may include a phone, tablet, laptop, or computer. The user device 190, for example, can include an application is executable by a controller 194 that allows the user to interact with the communication and control system 100 via a user interface 192. The user device 190 may communicate commands to the autonomous vehicle 110 and/or receive information about the autonomous vehicle 110 via transceiver 196 and/or the user device 190 may communicate commands with the base station 180 and/or receive information from the base station 180 via transceiver 196. Alternatively, or additionally, the user device 190, for example, can include an application that allows the user to observe the autonomous vehicle 110 move through a map of the work area where the autonomous vehicle operates. Alternatively, or additionally, the user device 190, for example, can provide images from one or more sensors of the sensor array 179.

The user device 190, for example, may include an application that can display any of the information disclosed in this document, such as visual data from cameras on the autonomous vehicle 190, and any inputs provided by the obstacle detection system 156.

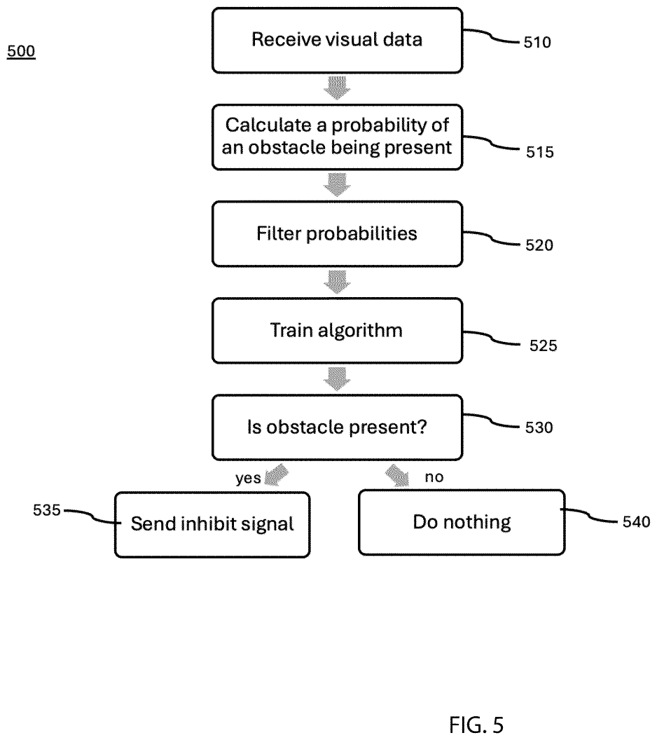

FIG. 5 is a flow chart of an example process 500 for controlling the autonomous vehicle 110 with an obstacle detection algorithm. Process 500 may be executed in part by, for example, the obstacle detection system 156.

Process 500 starts at block 510. At block 510, the obstacle detection system 156 may receive visual data. Visual data may be received from the sensor array 179, such as from a camera system including, for example, a front-facing camera, a rear-facing camera, and/or an internal camera. In some examples, the visual data may be received from different sources depending on the direction of travel or intended direction of travel of the autonomous vehicle 110. For example, the obstacle detection system 156 may receive velocity data including information relating to the direction of travel or intended direction of travel of the autonomous vehicle 110, and in the case that the velocity data indicates that the direction of travel or intended direction of travel of the autonomous vehicle 110 is forward, the visual data may be received from forward-facing cameras. In the case that the velocity data indicates that the direction of travel or intended direction of travel of the autonomous vehicle 110 is reverse, the visual data may be received from rear-facing cameras.

At block 515, the obstacle detection system 156 may calculate a probability or a probability distribution of an obstacle, or object being present based on the visual data. In particular, the obstacle detection system 156 may calculate a probability or probability distribution of a person being present within the field of view of any of the cameras in the sensor array 179. In some examples, process 500 may proceed straight to block 525 or to block 530 from block 515 and may omit either of blocks 520 and/or 525.

At block 520, the obstacle detection system 156 may filter the probabilities, or the probability distributions, through a Bayes filter, a hidden Markov model, or a moving average filter, using the visual data to determine a filtered probability.

At block 525, the obstacle detection system 156 may train a cascade classifier algorithm within the obstacle detection system 156, or a deep learning algorithm, such as a convolutional neural network producing calculated probabilities. Block 525 may be excluded from the process 500. Block 525 may occur outside of runtime, for example during development.

At block 530, the obstacle detection system 156 may compare the filtered probability, or if no filtering is performed, the probability, to a probability threshold to determine the presence of an obstacle, or object. In particular, if the probability or filtered probability are at or above the threshold probability, such as 80% or 0.8, then a determination may be made that an obstacle is present and the process may proceed to block 535, and if they are below the probability threshold, then a determination may be made that an obstacle is not present and the process may proceed to block 540.

At block 535, a determination has been made that an obstacle is present, and therefore the obstacle detection system 156 may send an inhibit signal to the vehicle control unit 150 and/or to the obstacle avoidance unit 158 to inhibit movement of the autonomous vehicle 110. This is particularly important in the case of an obstacle in the form of a person being detected by the obstacle detection system 156. If the obstacle detection system 156 is still active or if the inhibit signal has been overridden, the process may return to block 510 to repeat.

Using visual data from cameras, rather than from other sensors, may enable identification of people or animals specifically, as distinct from any other obstacles or objects. While collision avoidance with any obstacle is optimal, it is particularly important to avoid collisions with people and animals, and visual data from cameras can be used to recognize obstacles in the form of people and animals. For example, the methods and processes described herein may only inhibit movement of the autonomous vehicle in the case that the obstacle identified is a person or animal, and to steer around the obstacle or object if it is determined to be anything other than a person or animal. In some examples, the obstacle detection system 156 may be configured to only identify obstacles in the form of people or animals. In other words, the obstacle detection system 156 may be configured to distinguish between obstacles in the form and people and animals, and any other objects, and only to send an inhibit signal to the vehicle control unit 150, when a person or animal is detected. There may be a different collision avoidance system which is configured to identify obstacles and objects in order to steer around them.

At block 540, a determination has been made that an obstacle is not present, and so the obstacle detection system 156 does nothing to inhibit the movement of the autonomous vehicle 110. If the obstacle detection system 156 is still active, the process may return to block 510.

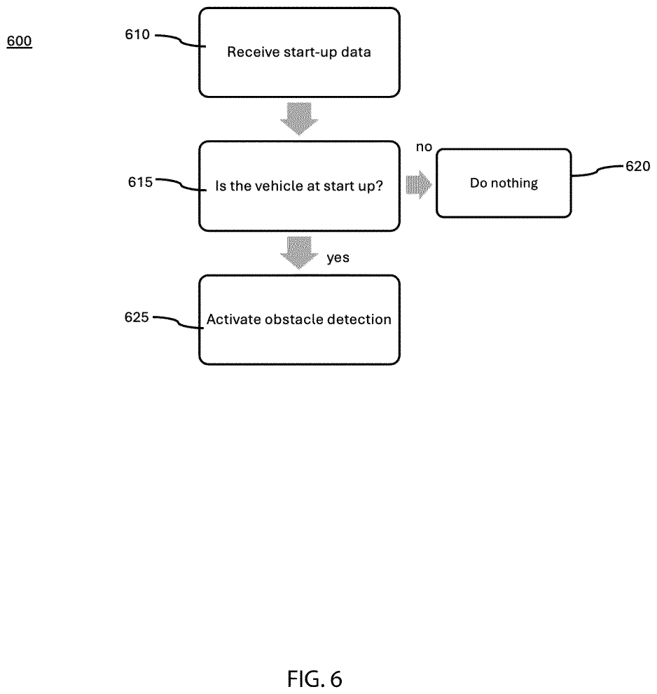

FIG. 6 is a flow chart of an example process 600 for activating the obstacle detection system 156 or an obstacle detection algorithm within the obstacle detection system 156. In the event that the obstacle detection system 156 is not always active, there may be conditional criteria for activating the obstacle detection system 156, which may be implemented with one or more blocks of the process 600 in FIG. 6. Process 600 may be executed in part by an obstacle detection activation subsystem, which may be the vehicle control unit 150 to activate the obstacle detection system 156, or the obstacle detection system 156 to activate an obstacle detection algorithm within it.

Process 600 starts at block 610. At block 610, the obstacle detection activation subsystem may receive start-up data from the sensor array 179 or from the vehicle control unit 150. Start-up data may indicate whether the autonomous vehicle 110 is at start up, or whether it has been operating for some time, or whether it has already moved since start-up of the autonomous vehicle 110.

At block 615, the obstacle detection activation subsystem may determine, based on the start-up data, whether the autonomous vehicle 110 is at start-up. If the autonomous vehicle 110 has moved since it has been started up, then it may be determined that it is not at start-up, and the process may proceed to block 620. At block 620, the obstacle activation subsystem does nothing and, the process may return to block 610. If the autonomous vehicle 110 has not moved since it has been started up, then it may be determined that it is at start-up, and the process may proceed to block 625.

At block 625, the obstacle detection activation subsystem may activate the obstacle detection system 156 or the obstacle detection algorithm as described with reference to FIG. 5.

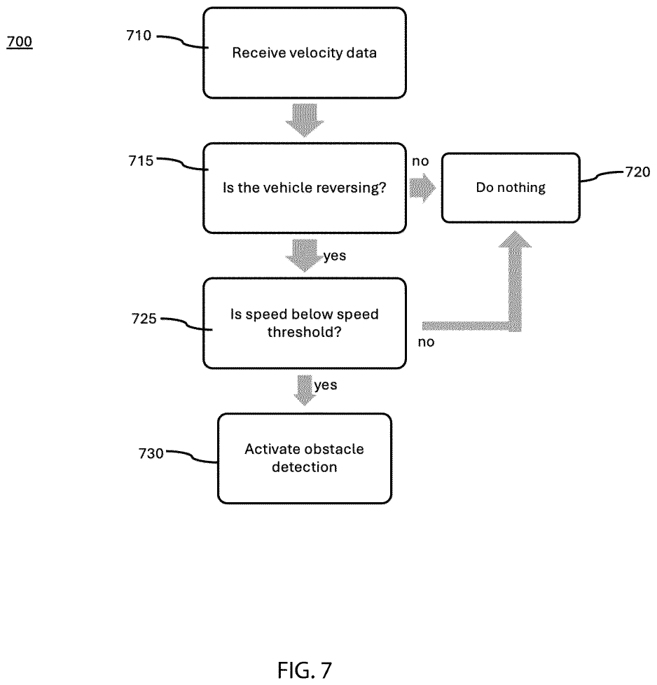

FIG. 7 is a flow chart of another example process 700 for activating the obstacle detection system 156 or an obstacle detection algorithm within the obstacle detection system 156. In the event that the obstacle detection system 156 is not always active, there may be conditional criteria for activating the obstacle detection system 156, which may be implemented with one or more blocks of process 700 in FIG. 7. Process 700 may be executed in part by an obstacle detection activation subsystem, which may be the vehicle control unit 150 to activate the obstacle detection system 156, or the obstacle detection system 156 to activate an obstacle detection algorithm within it.

Process 700 starts at block 710. At block 710, the obstacle detection activation subsystem may receive velocity data. This may include data on the speed of the autonomous vehicle 110 as well as its direction, such as forward moving or reversing. The velocity data may be received from a sensor array 179 including a speed sensor, or may be received from the vehicle control unit 150 as the intended speed from the speed control system 146, and intended direction of movement from the steering control system, as distinct from an actual or measured speed and direction of movement. For example, the autonomous vehicle 110 may not be moving, but the vehicle control unit 150 may send a command to the speed control system 146 to begin movement by reversing or by going forwards, and the velocity data may include the command to the speed control system 146. In other examples, the autonomous vehicle 110 may already be moving, and the vehicle control unit 150 may send a command to the speed control system 146 to control the speed at 7 miles per hour, and the actual speed may be measured by a speed sensor. The velocity data may include the command for the speed control and/or the actual speed from the speed sensor. In some examples, process 700 may proceed to block 715. In other example, process 700 may proceed directly to block 725 from block 710, and may omit block 715.

In block 715, the obstacle detection activation subsystem may determine whether the autonomous vehicle 110 is reversing based on the velocity data. If it is determined that the autonomous vehicle 110 is not reversing or intending to reverse (i.e., it is going forwards or not moving), the process 700 may proceed to block 720. If it is determined that the autonomous vehicle 110 is reversing or is about to start reversing, the process 700 may proceed to block 725. In this example, the sensor array 179 on the autonomous vehicle 110 may comprise a rear-facing camera, and the obstacle detection system 156 may use visual data from the rear-facing camera in the obstacle detection algorithm described with reference to FIG. 5. In some examples, the process 700 may proceed directly to block 730 from block 715, and may omit block 725. In other examples, the process 700 may proceed to block 720 from block 715 if the vehicle is determined to be reversing or about to start reversing, and may proceed to block 725, or 730 if the vehicle is determined not to be reversing, or about to start reversing.

At block 720, the obstacle detection activation subsystem does nothing, and the process 700 may return to block 710.

At block 725, the obstacle detection activation subsystem may determine whether the speed of the autonomous vehicle 110 is below a speed threshold based on the speed data. If it is determined that the speed of the autonomous vehicle 110 is not below a speed threshold, the process 700 may proceed to block 720. If it is determined that the speed of the autonomous vehicle 110 is below a speed threshold, the process 700 may proceed to block 730. In other examples, at block 725, process 700 may proceed to block 720 if the speed of the autonomous vehicle is determined to be below a speed threshold and may proceed to block 720 if the speed of the autonomous vehicle is determined not to be below a speed threshold.

At block 730, the obstacle detection activation subsystem may activate the obstacle detection system 156 or the obstacle detection algorithm.

The order of the various blocks in processes 500, 600, and/or 700 can occur in any order. Additionally, or alternatively, one or more blocks may be skipped, one or more blocks may be performed in parallel, and/or one or more blocks may be combined, and/or one or more blocks may be performed in any number of sub-blocks.

The computational system 800, shown in FIG. 8, can be used to perform any of the examples disclosed in this document. For example, computational system 800 can be used to execute processes 500, 600 and 700. As another example, computational system 800 can perform any calculation, identification and/or determination described here. Computational system 800 includes hardware elements that can be electrically coupled via a bus 805 (or may otherwise be in communication, as appropriate). The hardware elements can include one or more processors 810, including without limitation one or more general-purpose processors and/or one or more special-purpose processors (such as digital signal processing chips, graphics acceleration chips, and/or the like); one or more input devices 815, which can include without limitation a mouse, a keyboard and/or the like; and one or more output devices 820, which can include without limitation a display device, a printer and/or the like.

The computational system 800 may further include (and/or be in communication with) one or more storage devices 825, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 800 might also include a communications subsystem 830, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 830 may permit data to be exchanged with a network (such as the network described below, to name one example), and/or any other devices described in this document. The computational system 800, for example, may include a working memory 835, which can include a RAM or ROM device, as described above.

The computational system 800 also can include software elements, shown as being currently located within the working memory 835, including an operating system 840 and/or other code, such as one or more application programs 845, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 825 described above.

The storage medium, for example, might be incorporated within the computational system 800 or in communication with the computational system 800. The storage medium might be separate from a computational system 800 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 800 and/or might take the form of source and/or installable code, which, upon compilation and/or installation on the computational system 800 (e.g., using any of a variety of generally available compilers, installation programs, compression/decompression utilities, etc.) then takes the form of executable code.

Although term “autonomous vehicle” includes manned vehicles, remote control vehicles, manual vehicles, etc.

Unless otherwise specified, the term “substantially” means within 7% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more examples disclosed in this document. Any suitable programming, scripting, or other type of language or combinations of languages may be used to implement the teachings contained in software to be used in programming or configuring a computing device.

Embodiments of the methods disclosed may be performed in the operation of such computing devices. The order of the blocks presented in the examples above can be varied, for example, blocks can be re-ordered, combined, and/or broken into sub-blocks. Certain blocks or processes can be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific examples, those skilled in the art, upon attaining an understanding of these examples, may readily produce alterations to, variations of, and equivalents to such examples. Accordingly, the present disclosure has been presented for purposes of example rather than limitation, and does not preclude inclusion of such modifications, variations and/or additions to the present subject matter as would be readily apparent to one of ordinary skill in the art.

1. An autonomous vehicle comprising:
a camera system;
a controller;
a vehicle speed sensor configured to determine the speed of the autonomous vehicle; and
an obstacle detection system in communication with the camera system, wherein the obstacle detection system is configured to:
receive visual data from the camera system; and
calculate a probability of an obstacle being present based on the visual data; and wherein the controller is configured to:
determine the presence of an obstacle if a calculated probability in the obstacle detection system is above a probability threshold; and
send an inhibit signal to stop or inhibit movement of the autonomous vehicle;
wherein the controller is configured to:
receive speed data from the vehicle speed sensor, and,
determining if the speed of the autonomous vehicle is below a speed threshold based on the speed data, and
if the speed is determined to be below the speed threshold, activate the obstacle detection system.

2. The autonomous vehicle according to claim 1, wherein the controller is configured to activate the obstacle detection system at start-up of the autonomous vehicle.

3. The autonomous vehicle according to claim 1, wherein the controller is configured to keep the obstacle detection system active at all times during autonomous operation.

4. (canceled)

5. The autonomous vehicle according to claim 1,
wherein the controller is configured to:
receive speed data from the vehicle speed sensor, and,
determine if the speed of the autonomous vehicle is above a speed threshold based on the speed data; and
if the speed is above a speed threshold, activate the obstacle detection system.

6. The autonomous vehicle according to claim 1, wherein the camera system comprises a front-facing camera to provide visual data of the front and/or front sides of the autonomous vehicle.

7. The autonomous vehicle according to claim 1, wherein the camera system comprises a camera facing an operator seat on the autonomous vehicle.

8. The autonomous vehicle according to claim 1, wherein the camera system comprises a camera selected from the group consisting of a camera with a fish-eye lens, an electro-optical camera, a stereo camera, a depth camera, an infrared camera, a neuromorphic camera, and a hyperspectral camera.

9. The autonomous vehicle according to claim 1, wherein the camera system comprises a rear-facing camera, and wherein the controller is configured to activate the obstacle detection system when the vehicle is reversing.

10. The autonomous vehicle according to claim 1, wherein calculated probabilities are filtered based on a Bayes filter, a hidden Markov model, or a moving average filter.

11. The autonomous vehicle according to claim 1, wherein the obstacle detection system comprises a cascade classifier or deep learning algorithm.

12. The autonomous vehicle according to claim 1, wherein the autonomous vehicle is a mower, a yard truck, a loader, a wheel loader, a track loader, a dump truck, a digger, a backhoe, a forklift, a harvester, a tractor, a land leveler, a scraper, a dozer, a trencher, a grader, a seeder, a fertilizer, or a harrow.

13. method of controlling an autonomous vehicle, the method comprising:
activating an obstacle detection algorithm including:
receiving visual data relating to data from a camera system on the autonomous vehicle;
calculating a probability of an obstacle being present based on the visual data;
if the probability is above a probability threshold:
determining the presence of an obstacle; and
sending an inhibit signal to stop or inhibit movement of the autonomous vehicle;
receiving speed data relating to speed of the autonomous vehicle;
determining if the speed of the autonomous vehicle is below a speed threshold based on the speed data; and
if the speed is determined to be below the speed threshold, activating the obstacle detection system.

14. The method according to claim 13, comprising determining whether the autonomous vehicle is at start-up, and activating the obstacle detection system if it is determined to be at start-up.

15. The method according to claim 13, comprising determining whether the autonomous vehicle is operating autonomously, and keeping the obstacle detection system active at all times during autonomous operation.

16. (canceled)

17. The method according to claim 13, further comprising:
determining if the speed of the autonomous vehicle is above a speed threshold based on the speed data;
if the speed is determined to be above the speed threshold, activating the obstacle detection system.

18. The method according to claim 13, wherein the camera system comprises a rear-facing camera, and wherein the method comprises:
determining whether the vehicle is being controlled to reverse, and
if the vehicle is being controlled to reverse, activating the obstacle detection system.

19. The method according to claim 13, comprising filtering, based on a Bayes filter, a hidden Markov model, or a moving average filter, calculated probabilities.

20. The method according to claim 13, wherein the autonomous vehicle is a mower, a yard truck, a loader, a wheel loader, a track loader, a dump truck, a digger, a backhoe, a forklift, a harvester, a tractor, a land leveler, a scraper, a dozer, a trencher, a grader, a seeder, a fertilizer, or a harrow.

21. (canceled)

22. An autonomous vehicle comprising:
a camera system;
a controller;
a vehicle speed sensor configured to determine the speed of the autonomous vehicle; and
an obstacle detection system in communication with the camera system, wherein the obstacle detection system is configured to:
receive visual data from the camera system; and
calculate a probability of an obstacle being present based on the visual data; and wherein the controller is configured to:
determine the presence of an obstacle if a calculated probability in the obstacle detection system is above a probability threshold; and
send an inhibit signal to stop or inhibit movement of the autonomous vehicle;
wherein the controller is configured to:
receive speed data from the vehicle speed sensor, and,
determining if the speed of the autonomous vehicle is above a speed threshold based on the speed data, and
if the speed is determined to be above the speed threshold, activate the obstacle detection system.

23. method of controlling an autonomous vehicle. the method comprising:
activating an obstacle detection algorithm including:
receiving visual data relating to data from a camera system on the autonomous vehicle;
calculating a probability of an obstacle being present based on the visual data;
if the probability is above a probability threshold:
determining the presence of an obstacle; and
sending an inhibit signal to stop or inhibit movement of the autonomous vehicle;
receiving speed data relating to speed of the autonomous vehicle;
determining if the speed of the autonomous vehicle is above a speed threshold based on the speed data; and
if the speed is determined to be above the speed threshold, activating the obstacle detection system.
